(19) United States
(12) Patent Application Publication
(10) Pub. No.: US 2012/0209662 A1
(43) Pub. Date: Aug. 16, 2012

(54) Dynamic Pricing

(75) Inventors: Barry Kahn, Austin, TX (US); Daniel Keshet, Austin, TX (US); Walter Bodwell, Austin, TX (US)

(73) Assignee: QCUE, INC., Austin, TX (US)

(21) Appl. No.: 13/458,194

(22) Filed: Apr. 27, 2012

Related U.S. Application Data
(63) Continuation of application No. 12/897,200, filed on Oct. 4, 2010.
(60) Provisional application No. 61/365,104, filed on Jul. 16, 2010.

(51) Int. Cl. G06Q 10/04; G06Q 30/00

(52) U.S. Cl. 705/7.31; 705/26.4

(57) ABSTRACT

The system and method of the present invention includes a predictive model for ticket sales. In one embodiment, the model predicts ticket sales as a function of the quality of the event and the quality of the section in which the seat is located over a range of ticket prices. The present invention also includes a system and method for dynamically pricing tickets wherein the aforementioned sales projections, coupled with real-time factors relating to the characteristics of the game and the remaining tickets, are used to optimize ticket prices to maximize revenue at the venue.

### PRIORITY STATEMENT UNDER 35 U.S.C. §119 & 37 C.F.R. §1.78

The present application is a continuation application of U.S. patent application Ser. No. 12/897,200 filed Oct. 4, 2010 in the names of Barry S. Kahn, Daniel Keshet and Walter Bodwell, entitled “Dynamic Pricing”, which claims priority based upon prior U.S. Provisional Patent Application Ser. No. 61/365,104 filed Jul. 16, 2010 in the name of Barry Kahn entitled “Dynamic Pricing,” the disclosure of which is incorporated herein in its entirety by reference.

### BACKGROUND

Many tickets for entertainment events such as sporting events, musical concerts, and other live events, are purchased electronically via, for example, the Internet. Conventional ticket reservation systems, such as seat reservation at an event held at a stadium, allow the purchaser to select the seat and to pay a fixed price for that seat. As the number of remaining seats diminishes, the price for seats in the same area remains the same. As a result, purchasers of the remaining seats are able to purchase those scarce seats at the same price as the purchaser who purchased when the supply was plentiful. Similarly as factors change to cause an event to be of higher (or lower) demand or the rate of sales indicates an incorrect initial estimation of demand, prices do not adjust to account for this new information. This results in a market in which the seller is not able to maximize revenue and the early purchaser is not rewarded for purchasing when seats are plentiful.

Ticket sales are generally a function of the quality of the event (determined by characteristics of the event), the quality of the seats at the event, and the price of the tickets for those seats. Because many ticket sales projections methods known in the art fail to properly model consumer preferences, they remove the potential to anticipate consumer reactions and lack the potential to accurately project sales, and instead rely on a trial and error approach of real-time experiments, such as those described in U.S. Pat. Nos. 7,330,839 by Kannan and Shamos (2008), 7,587,372 by Eglen et al. (2009), and 7,080,030 by Eglen et al. (2006).

By way of further example, U.S. Patent Application No. 2009/0216571 by Sunshine et al. teaches a system and method for determining prices and distribution channels for event tickets. The system “dynamically matches prices with demand” by adjusting, or “flexing” ticket prices according to “demand variables” such as web site traffic, sales in the secondary market, prior sales, opponent, day of the week, etc. As tickets are being sold, the price of tickets is adjusted to reflect changes in these demand variables. Sunshine discusses using event quality to “create groupings of events” in connection with sales of multi-event ticket packages, but does not teach or describe the use of event quality in predicting sales of seats in a venue.

U.S. Patent Application No. 2007/0162301 by Sussman, et al. teaches a system and method for dynamically setting ticket prices wherein an initial seat ticket price is set for a first event based on historical sales data and on historical event-related income data, monitoring ticket sales data for the first event, and setting a second seat ticket price after the first event has begun based in part on the historical sales data and a pre-determined adjustment limit. Once again, ticket prices are adjusted during the event based historical data, but ticket sales are not predicted based on the quality of the event and the quality of the section as a function of ticket price.

Thus, there is a need for a method and system that takes into account the consumer's preference for the event, the consumer's preferences across all available sections in which seats are located, and the ticket prices for the seats in order to accurately predict ticket sales at an event, distributed across sections, over a range of prices.

### SUMMARY

The invention provides a new and useful system and method for predicting ticket sales for an event at a venue and for pricing tickets to optimize sales of seats for an event at a venue. More specifically, a method of predicting ticket sales is provided wherein the value of a seat is determined from the value of the section, the value of the event and the price of tickets. The value of the event can be quantified by determining the difference between projected sales and actual sales for historical events with similar characteristics. The value of the section can be determined by comparing the historical sales activity for the section in which the seat is located with other sections within the venue.

The pricing method and system of the present invention uses the sales projections described above with sales and demand monitoring (monitoring of real-time factors that affect sales projections, primarily changes to characteristics of the game and tickets remaining) to optimize ticket prices for an event at a venue.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a screen shot of one embodiment of an Administrative Venue page;

FIG. 2 is a screen shot of one embodiment of an Administrative Events page;

FIG. 3 is a screen shot of one embodiment of a Category Types page;

FIG. 4 is a screen shot of one embodiment of a Category Type Details page;

FIG. 5 is a screen shot of one embodiment of an Administrative Season page;

FIG. 6 is a plot showing time vs. ticket sales for a particular event;

FIG. 7 is a screen shot of one embodiment of an Approve Prices page;

FIG. 8 is a schematic illustration of one embodiment for pricing and selling tickets; and

FIG. 9 a hardware block diagram illustrating the hardware component of a server computer executing the mechanism for pricing and selling tickets in accordance with the description herein.

### DETAILED DESCRIPTION

The present invention is directed to an improved method and system for predicting ticket sales and pricing tickets for an event at a venue. The configuration and use of the presently preferred embodiments are discussed in detail below. It should be appreciated, however, that the present invention provides many applicable inventive concepts that can be embodied in a wide variety of contexts other than traditional ticket sales at a venue, including any financial, management or cost/price determination system used in connection with allocation of a fixed amount of quantity and/or time. Accordingly, the specific embodiments discussed are merely illustrative of specific ways to make and use the invention, and do not limit the scope of the invention. In addition, the following terms shall have the associated meaning when used herein:

“event” means any event for which tickets for seats are sold, including without limitation, sporting events, arts events, entertainment events and the like;

“sales” means the total quantity of tickets sold for an event and the distribution of those sales across different seating areas;

“seat” means any space that is discernable and reservable within a venue including, without limitation, a chair, bench, wheelchair space, standing area, lawn area, parking space, anchor locations and the like;

“section” means an area of a venue and is not restricted to a physical section. It can refer to, without limitation, a group of seats, a price scale, a collection of rows, or an individual seat; and

“venue” means a location within which events are held.

There are three main reasons that prices change over time. First, sales are faster or slower than expected making sellout constraints more or less likely. This can occur either for individual sections or an event as a whole. Ignoring all other sections, when sellout constraints are met in projections, it results in increases from the unconstrained price. Also, as dictated by customer preferences, the last seats in each section, and to a greater extent, the stadium as a whole, are more valuable since there are some fans that are willing to pay more to sit in that section, or to get into the event. As sellouts approach, prices naturally rise to account for the decreased availability relative to demand.

Second, forecasting is updated since sales to date deviate from expected. This can result in a change in the event value, resulting in different prices, or sales above or below projected, necessitating higher or lower prices, respectively, to adjust the sales trend to an optimal level.

Third, changing customer types over time should cause changing prices to be offered over time. A significant shift in airline pricing occurred when it was realized that there existed two different customer types, business and leisure travelers. The present invention facilitates the segmentation of customers by buying patterns that can result in prices changing with changing customer types. This is already seen with walk-up sales where higher prices are charged since a fan that is already at the stadium is less price sensitive than a fan buying in advance.

When pricing tickets for an event at a venue, dynamic pricing is a combination of demand discovery and revenue management. Demand discovery is finding the true value of a unique event that has not happened before and revenue management is managing the allocation of capacity over time to maximize revenue. It is not possible to effectively manage revenue without first understanding the demand for the event. Once demand is known, ticket sales can be predicted and ticket prices can be optimized.

As used in this specification, sales projections are a model of fan behavior that projects forward-looking sales and revenue at any set of prices. This includes, for example, the percentage of fans that will buy tickets in each price scale, how those sales will occur over time, how overall sales are affected by sellouts in different sections, how the distribution of sales changes over time, and the associated revenue over time.

In order to properly project ticket sales, embodiments of the present invention utilize a model of customer behavior in which the average fan has a utility to buying a ticket in each section:

uₜ(vᵢ,pᵢ)

where vᵢ is the value of the seat, a combination of the value of section i and the value of the event, and pᵢ is the price of a ticket in section i and individual fans have preferences that follow a known distribution around the mean such that different fans can have different preferences across sections at the same set of prices.

The utility function can take on many different forms and certain embodiments of the present invention allow easy substitution of different functional forms of the utility function and for the calibration of the associated parameters to best match historical sales for that team, venue, artist, etc.

Using the assumption that customers purchase a ticket in the section that yields them the highest utility, if any, and aggregating this across all customers, it is possible, if desired, to model the probability of purchase in each section by a multinomial-logit function.

The value of the seat in the sales projection model is a function of section value and event quality. Section values are calibrated to best match historical sales. Every purchase can be viewed as a fan making decision between sections. Section values can be aggregated over millions of purchases each year, and the aggregation can be broken down, for example, by time, offered prices, discount codes, or events. Section values may be selected such that the distance between sales projections and actual sales is minimized.

Once section values are established, decreasing (increasing) the price of a section has two effects. First, it increases (decreases) the total probability of a customer buying a ticket. However, decreasing (increasing) the price of a section does not have the same effect in all sections. For example, decreasing (increasing) the price of the lowest priced section typically increases (decreases) the total probability of a sale more than decreasing (increasing) prices in a higher priced section. Second, it increases (decreases) the number of sales in that section relative to other sections.

The second variable in determining seat value is the quality of the event. By measuring the difference between sales projections and actual sales, it is possible to quantify the degree to which the event is better or worse than anticipated and a value can be assigned to the event to correct the projections in the future. Note that this is not a measure of sales alone, but sales at the set of prices offered. For example, a baseball game between Team A and Team B on a particular time of day and day of week may have been projected to sell X tickets when actual sales were actually 110% of X. The 10 percent increase in actual ticket sales over projected sales is an indication of a higher quality of the event than originally assigned.

The section value and the event quality are used to determine the value of the seats in a section. Calculating event values for completed events allow the prediction of event values for future events by accounting for shared characteristics. These characteristics can include start time, day of week, time of year, opponent, weather, promotions, etc. The value of these different characteristics can be determined by regression analysis on a set of completed events. For example, summer games may be predicted to have higher sales than spring or fall games and weekend games may be predicted to have higher sales than weekday games. While Sussman uses only events with matching characteristics to predict future sales for events, the event value approach outlined in this application allows the use of events with similar characteristics to determine the event value, while leveraging data a broader range of events to determine common values across all events, such as arrival patterns, seat values, and aggregate demographic preferences.

Once the seat values have been established, the sales projection model is used to determine ticket sales based on the seat values and the ticket prices. Because the value of the event and the value of the section are known, demand for seats can be predicted for a wide range of ticket prices.

Once the sales projections have been established, real-time factors that affect sales projections can be monitored and ticket sales can be adjusted accordingly. Examples of characteristics that affect sales projections include start time, opponent, weather, playoff implications, promotions, artist and the like. A change in one of these characteristics can cause the sales projections to change considerably, and they must, therefore, be included in any reliable method for pricing tickets.

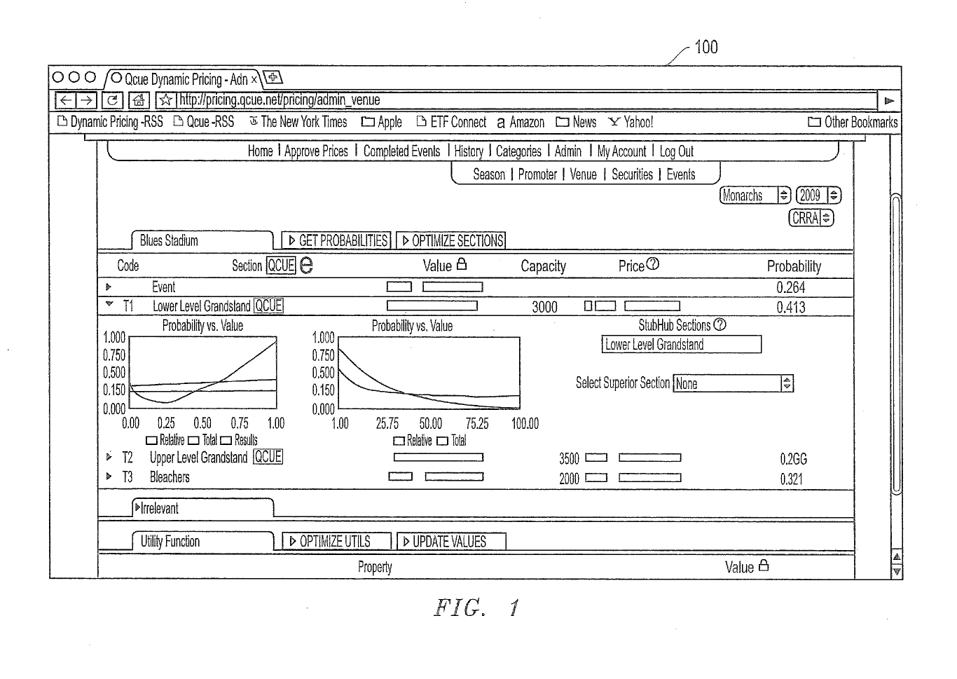

Referring now to the drawings wherein FIG. 1 is one embodiment of an Administrative Venue screen 100. Along the top, the options available are “Home,” “Approved Prices,” “Completed Events,” “History,” “Categories,” “Admin,” “My Account,” and “Log Out.” The body of the screen shows the implied probability of a sale in any section (Total) and the probability that a sale will occur in the specified section, given that a fan chooses to buy a ticket (Relative), change as the price of tickets in the Lower Level Grandstand varies from $1 to $100 as well as how those probabilities would change as the price is adjusted.

More specifically, the screen in FIG. 1 representing the fictional 2010 Kansas City Monarchs provides three tabs—“Blues Stadium” tab, an “Irrelevant” tab, and an “Utility Function” tab. On “Blues Stadium” tab, headings are provided for “Code,” “Section,” “Value,” “Capacity,” “Price,” and “Probability.” The Section column designates each particular section within Blues Stadium, with the icon “Qcue” next to a section name indicating that a section is dynamically priced, while the “Ø” next to a section name indicates that tickets in that section are not available for single event sales. Importantly, the model may be able to accommodate dynamic pricing in certain sections while statically pricing other sections. The Value column presents a sliding bar ranging from 0.0 to 1.0 depending on the perceived value of the section to the ticket purchaser. This value can be preset through an algorithm by clicking the “Optimize Values” button or can be adjusted by the user. The value of an event can similarly range from 0.0 to 1.0 and is only used on this page to affect the probability of purchase. The Capacity column indicates the capacity for the applicable section. The Price column again presents a sliding bar, which can range from an adjustable preset minimum to maximum and, like the event value, only has the purpose on this page to obtain probabilities of purchase that match a given event or to explore hypothetical scenarios. The Probability column, which only appears upon clicking the “Get Probabilities” button, designates the probability that a sold ticket will be sold in each section based on the designated values and prices of all sections and, on the event line, the total probability of purchase. When expanded, as shown for the Lower Level Grandstand in Blues Stadium, the probability of sales versus the value is shown graphically for Relative, Total, and Residual sales. In addition, the probability of sales versus ticket price is shown graphically for Relative and Total sales. While the algorithm designated by the administrator may be selected to minimize the distance between the sales projections and actual sales, the “Residual” line on the “Probability vs. Value” graph, the user may elect to adjust the value of one or more sections based on information available to the user or simply to model projected sales based on different criteria. Additionally, designating a “Superior Section” also causes probabilities of purchase to deviate from those implied by the multinomial-logit function in the case where a section has a price greater than or equal to its “Superior Section.”

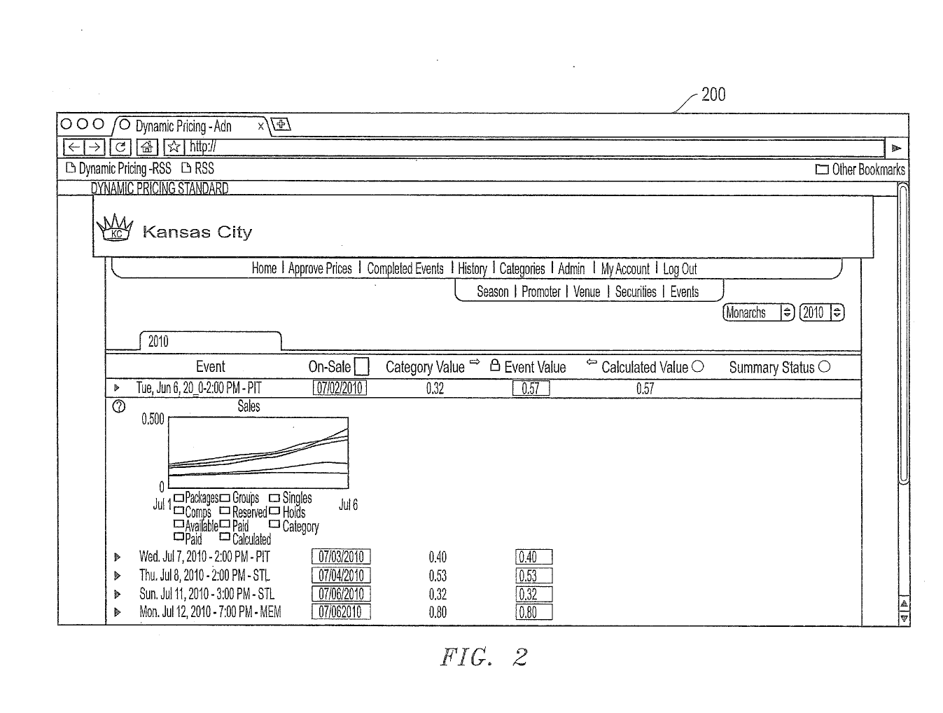

FIG. 2 depicts an embodiment of an Administrative Events page 200. As can be seen, events are initially valued based upon categories, a known set of characteristics about an event before it goes on-sale, but can be overridden as more accurate values are calculated during the season. The lines drawn over the sales graph represent sales projections at the event value as dictated by the category value, calculated value, and current event value.

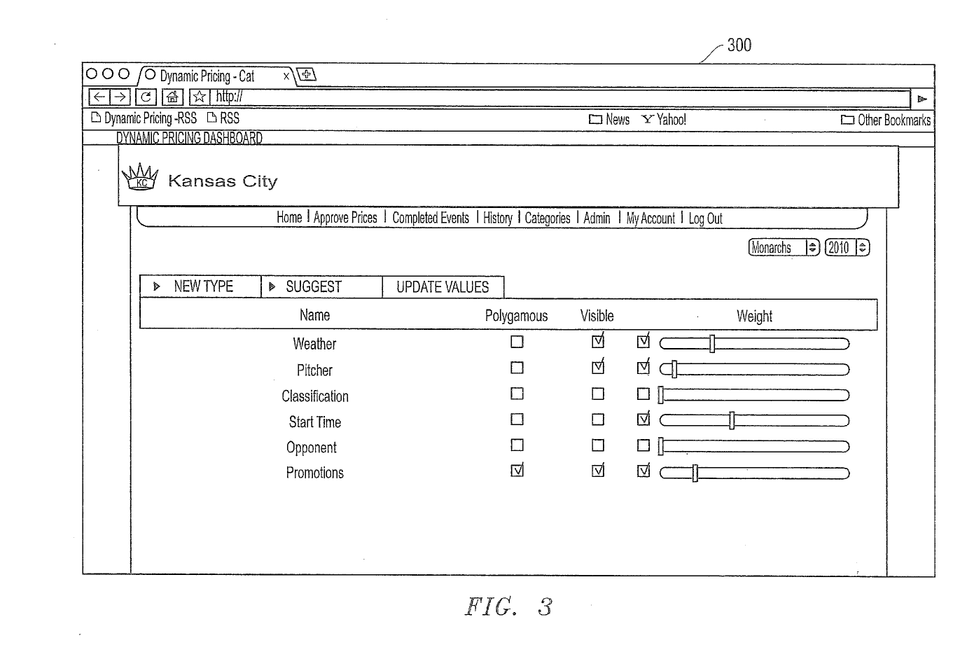

Categories are broken into different category types, as shown in FIG. 3, and the categories within the type. As can be seen in FIG. 3 from the Category Types page 300, the relevant category types for the fictional 2010 Kansas City Monarchs were the Date Time, Opponent, Promotions, and Pitcher. As can be seen, the primary driver was the Date Time, explaining ˜50% of the explainable variation, following by promotions and opponent, each explaining ˜25% of the variation, with a slight effect for pitchers.

While the promotions and opponent appear comparable, there are only a select few promotions with a strong enough effect to move demand (bobbleheads, fireworks, etc).

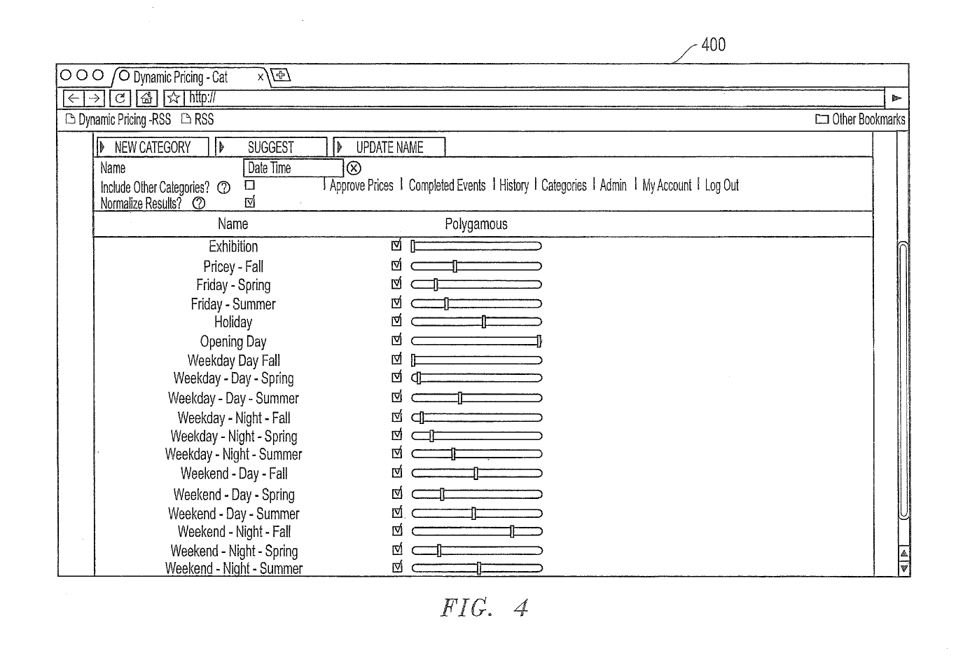

Examining the most relevant category, Date Time, on the Category Type Details page 400 included as FIG. 4, the relative importance of the different possible starting times can be seen. As expected, Opening Day yields the full value, while summer games are more valuable than spring or fall games, with that difference being more pronounced for weekdays than weekends.

It should also be noted that there are two slider bars in the “Value” column, representing the system's suggested value of the category through regression (or other) analysis and the currently set value. While the category value that is set is typically set to the suggested value, this does not need to be the case as the pricing system allows the user to override the suggested parameter value. This is a common theme in the software where users can override the calculated parameter (category, category type, event, section, etc) values to account for intrinsic knowledge that was unable to be included in the automated analysis.

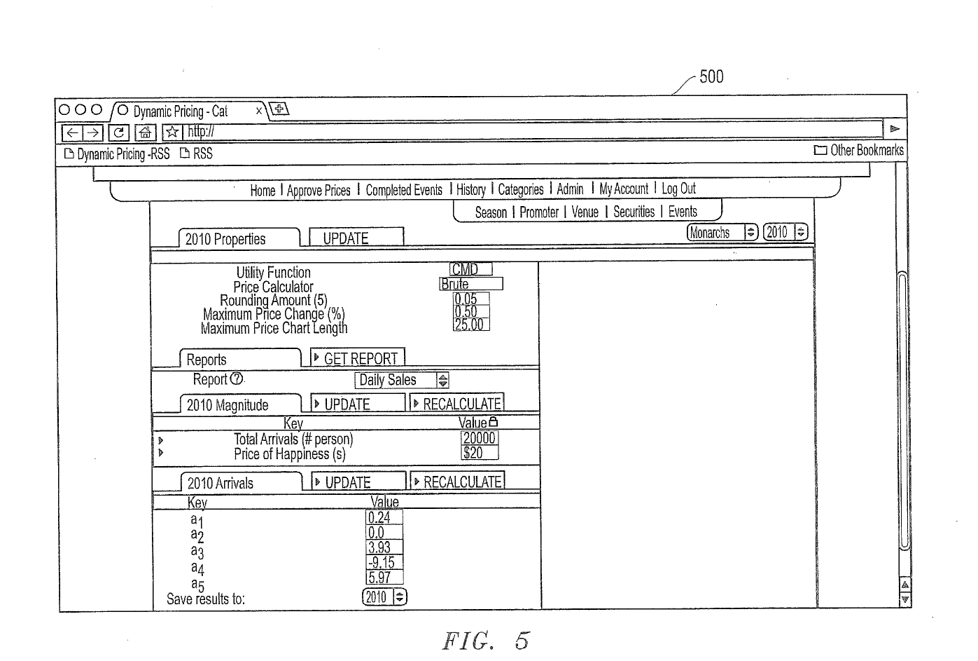

The pattern by which customers arrive to buy tickets is also mapped out and calibrated through the Administrative Season page 500 included as FIG. 5. An arrival is defined as a customer purchasing a ticket or making a decision to not purchase a ticket. In the case where prices remain constant and sections do not sell out, the ratio of sales to arrivals will be fixed. This understanding of future arrivals is critical for projecting future sales at different price points.

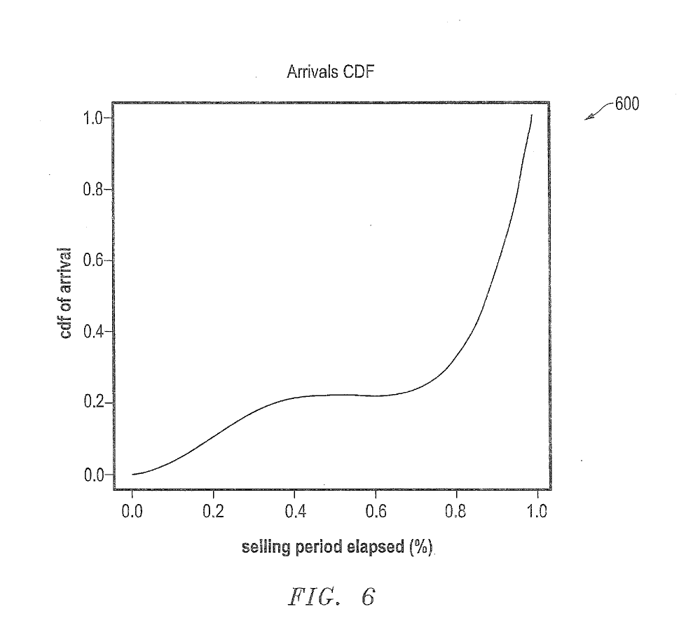

FIG. 6 shows the plot 600 that depicts how arrivals occurred for the fictitious Kansas City Monarch's 2009 season. The height represents the percentage of sales that have occurred to date measured against the percentage of the selling period that has passed. Note that at the time of the event, 100% of the sales will have occurred.

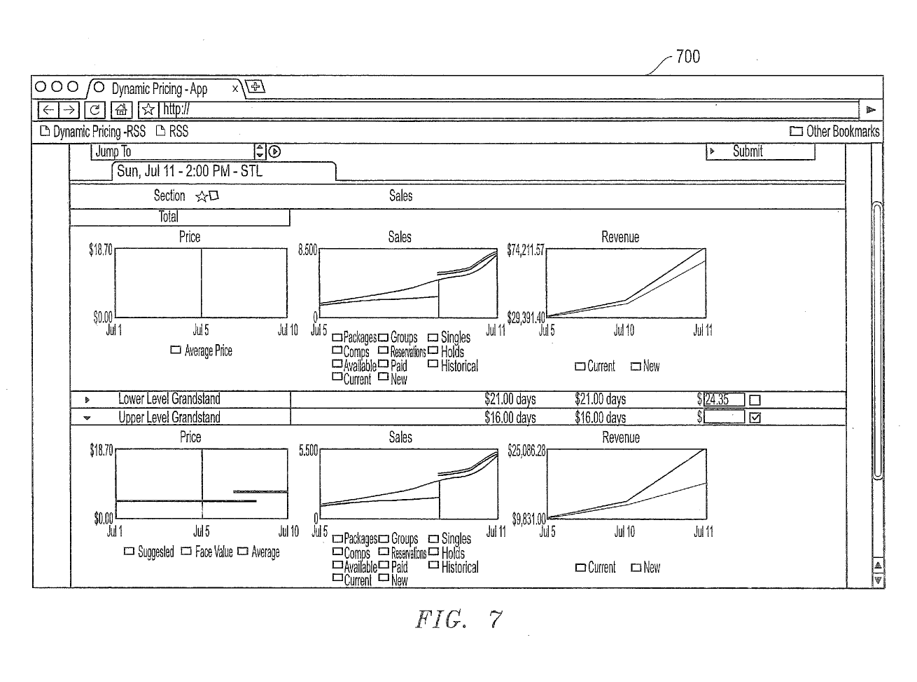

In this embodiment, prices are set to maximize expected revenue, however, in other embodiments it may be desirable to maximize other variables, such as ticket sales and ancillary spending, encourage advanced purchase by increasing prices over time, or follow other preset paths or rules. The price calculator, ie. the algorithm that dictates how prices adjust in response to sales, time, changes in event value, etc., is a configurable, changeable part of the system as seen on the Administrative Season Page in FIG. 5. In this embodiment, the price calculator is equivalent to trying to maximize the revenue from sales projections at an event level, displayed in FIG. 7. The result of the modeling described above is that at any point in time, at any set of prices, one is able to project sales and revenues for each game, broken down by section.

FIG. 7 shows one embodiment of an Approve Prices Page 700. In addition to displaying sales to date, the page shows sales and revenue projections at both the current prices and the suggested prices. The system can make these projections at any set of prices entered in the “New” box.

In FIG. 7, with a low price entered in the NEW box for the Upper Level Grandstand, the system projects that section to sell, but to result in lower revenue for both the section and the event as a whole despite higher sales.

Prices may be continuously set and reset to maximize the revenue according to these sales projections. From this page, the event value can be adjusted to deviate from suggested, characteristics of this event (such as promotions) can be added or removed, or sections can be locked at set prices such that further price optimization will require that section to maintain the locked price. Upon adjustments to the event or prices of sections, it is possible to have the system offer the new optimized prices by clicking the re-price button.

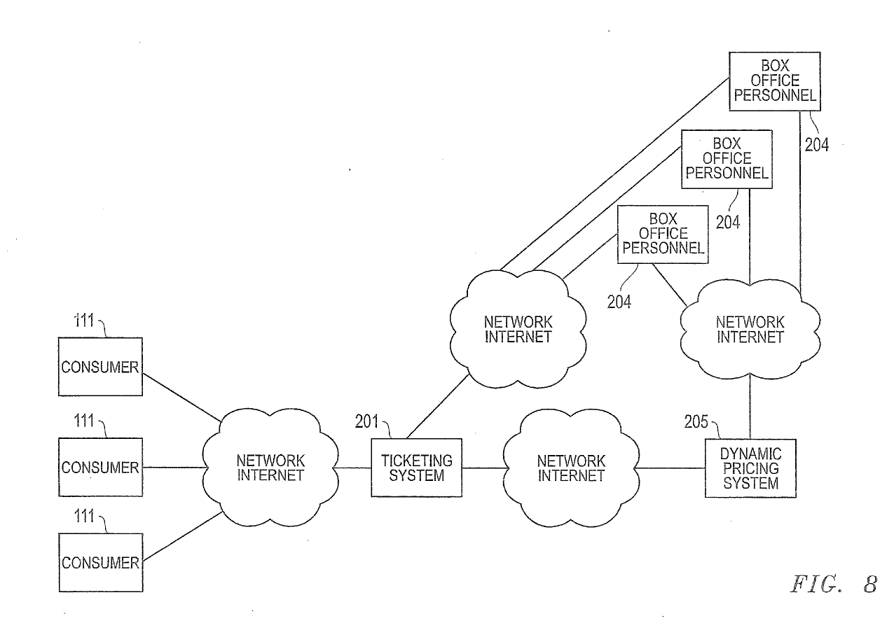

FIG. 8 is a schematic illustration of one embodiment for pricing and selling tickets according to the mechanisms described herein. In the embodiment of FIG. 8, end consumers 111 interact with a ticketing system 201 either over a network using a computer, via telephone calls over a telephone network, or even over the counter at a box office physical location. In the latter two alternatives, the interaction may be via an operator or clerk or via an automated attendant system. The ticketing system 201 is communicatively coupled to the dynamic pricing system 205 and box office personnel 204 are able to access and utilize the dynamic pricing system 205 via the Internet. The prices of tickets offered to consumers 111 through the ticketing system 201 are controlled by the dynamic pricing system 205. The dynamic pricing system 205 of the present invention is accessible by, and interacts with, the ticketing system 202 and box office personnel 204 so as to set or adjust ticket prices as further described herein.

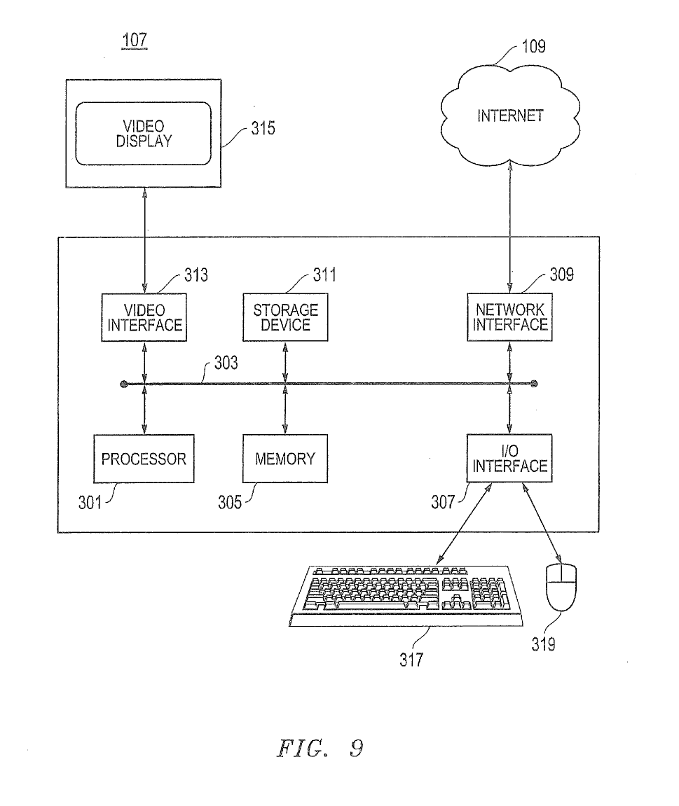

FIG. 9 is a hardware block diagram illustrating the hardware component of an exemplar ticket pricing and server computer 107. The ticket pricing and server computer 107 may consist of a central processing unit 301 connected via a bus 303 to a memory 305, an Input/Output (I/O) interface 307, a network interface 309 for connecting to the network 109, a storage device 311 for storing programs and data structures, e.g., data files and data bases, and a video interface 313 connecting to a video display 315. The I/O interface 307 is connected to a keyboard 317 and a mouse 319 to allow a user, e.g., an administrator of the ticket pricing and server 409, to interact with the ticket pricing and selling server computer 107. It will be appreciated that where this example refers to a central processing unit, a memory, a storage device, etc., in actual implementations of the systems and methods described herein, the functionality of these devices may advantageously be spread out over multiple devices, e.g., multiple processors, multiple memories, multiple storage devices, etc., respectively. Similarly, the functionality described herein may advantageously be distributed over multiple exchange server computers 107.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of possible methods and systems for dynamic pricing, the detailed embodiments are intended to be illustrative only and should not be taken as limiting the scope of the invention. Rather, what is claimed as the invention is all such modifications as may come within the spirit and scope of the following claims and equivalents thereto.

None of the descriptions in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

I claim:

1. A method of dynamically predicting sales for an event, comprising:
assigning a functional form on a computer, wherein said functional form describes ticket sales for an event at a venue as a function of value of said event, value of one or more sections in said venue, and price of said tickets;
establishing a numerical value corresponding to said value of said event;
establishing a numerical value corresponding to said value of each of said one or more section; and
predicting sales at said event based on said numerical value corresponding to said value of said event, said numerical value corresponding to said value of said one or more sections, and said price of said tickets.

2. The method of claim 1, wherein said numerical value corresponding to said value of said event is determined by using said functional form to determine which numerical value corresponding to said value of said event best approximates ticket sales for a historical event at said venue for known values of said one or more sections, known ticket prices, known available quantities, and known ticket sales.

3. The method of claim 1, wherein said numerical value corresponding to said value of said one or more sections is determined by using said functional form to determine which numerical value corresponding to said value of said one or more sections best approximates ticket sales for a historical event or set of events at said venue for a known value of event, known ticket prices, and known ticket sales.

4. The method of claim 1, wherein a user can adjust said numerical value of said event corresponding to said value of said event to predict ticket sales in said venue.

5. The method of claim 1, wherein a user can adjust said numerical value corresponding to said value of said event or said numerical values corresponding to said values of said one or more sections to predict ticket sales in said venue.

6. The method of claim 1, wherein a user can adjust said ticket prices to predict ticket sales in said venue.

7. The method of claim 1, wherein a user can adjust said ticket prices to maximize projected revenue for said event.

8. The method of claim 1, wherein said event includes one or more of a sporting event, arts event, or entertainment event.

9. The method of claim 1, wherein a user can view the probability of sales in a given section dependent upon the price of tickets in that section, given prices in all other sections and the value of said event.

10. A system for pricing tickets, comprising:
presenting a user with the option to choose from a list of algorithms for changing ticket prices;
presenting said user with a set of properties affecting one or more of said algorithms;
using one or more of said algorithms, as modified by said properties, to determine a proposed ticket price;
presenting said proposed ticket price to said user;
presenting said user with an option of publishing said proposed ticket price to one or more third party third party systems or publishing an alternative ticket price to one or more third party systems.

11. The system of claim 10, wherein said functions performed by said algorithms include one or more of brute force static price optimization, observed demand over expectation, rescale price across venue, changes to supply constraint and changes event value.

12. The system of claim 10, wherein said properties includes one or more of rounding amount, maximum price change, increase only, quantity dampening and supply threshold.

13. A system for pricing tickets, comprising
a computer utilizing an algorithm for proposing ticket prices for a section of a venue holding an event;
an interface for displaying said proposed ticket prices for said section to a user;
receiving said user's acceptance of said proposed ticket price or designation of an alternative ticket price;
wherein, if said user accepts said proposed ticket price, publishing said proposed ticket price to one or more third party systems for use in the sale of tickets to potential purchasers; and
wherein, if said user designates an alternative ticket price, publishing said alternative ticket price to one or more third party systems for use in the sale of tickets to potential purchasers.

14. The system of claim 13, wherein said use in the sale of tickets is the display of said proposed ticket price or said alternative ticket price on said one or more third party systems.

15. The system of claim 13, wherein said use in the sale of tickets is the updating of the price of said tickets in the database of said one or more third party systems.

16. The system of claim 13, wherein said publishing is through an application programming interface.

17. The system of claim 13, wherein said publishing is through an automated process.

18. The system of claim 13, wherein said third party system provides said user with information regarding sales of said tickets.

19. The system of claim 13, wherein said system receives information regarding the sale of said tickets from said one or more third party systems.
